(19) United States
(12) Patent Application Publication
(10) Pub. No.: US 2005/0076131 A1
(43) Pub. Date: Apr. 7, 2005

(54) Protocol and system for the automatic and simultaneous distribution of electronic documents of different formats on the Internet

(76) Inventors: Christophe Paimparay, Lannion (FR); Emmanuel Moniz, Lannion (FR)

Correspondence Address: YOUNG & THOMPSON, 745 SOUTH 23RD STREET, 2ND FLOOR, ARLINGTON, VA, 22202, US

(21) Appl. No.: 10/735,635

(22) Filed: Dec. 16, 2003

(30) Foreign Application Priority Data
Dec. 16, 2002 (FR) 0215940

(51) Int. Cl. G06F 15/16

(52) U.S. Cl. 709/228

(57) ABSTRACT

Protocol and system for the automatic and simultaneous distribution of different electronic documents on the Internet between different users in the course of a common session by access to a dedicated server (DS). An organizer user initializes the session, the initialization comprising at least the drawing-up of a list of surnames, first names, and electronic addresses of the invited users, and selects the electronic documents to be distributed. Transmission is effected to the dedicated server. The documents of the list are converted into pages in the unique HTML format. A message of invitation to participate in the session is transmitted from the server to each invited user, the message comprising at least the address of the server, the date, and the time of the session. Access for each of the users to is authorized conditionally.

The invention relates to a protocol and to a system for the automatic and simultaneous distribution of electronic documents of different formats on the Internet.

### BACKGROUND OF THE INVENTION

At the moment, users of work stations benefit from a great variety of methods of access to the Internet network. Amongst these access methods, connection by modem by means of the switched telephone network (STN), connection by high-speed modem (ADSL), or connection to the Internet network by means of a local network protected by a firewall may be mentioned in particular.

The above-mentioned different methods of connection and access involve constraints which are also due to the security elements of firms' networks, also referred to as local networks.

In particular, there is at the moment no integrated service which can offer automatic and simultaneous display of the same electronic document, irrespective of its original format.

Amongst the various solutions proposed to Internet users, the simultaneous distribution of Web pages requires the installation of specific software at the work station of each of the participants in a working session or meeting.

Other solutions require the addition of supplementary software known as “plug-in” software which is grafted onto the Internet navigator software, this type of software depending on the type of Internet navigator and on the operating system used by the terminal of the user concerned.

The object of the present invention, however, is to overcome the disadvantages of the solutions currently proposed.

### BRIEF SUMMARY OF THE INVENTION

In particular, an object of the present invention is to put into effect a protocol and a system for the automatic and simultaneous distribution of electronic documents of different formats on the Internet, enabling users of work stations situated in any locations and accessing the Internet and/or the intranet by means of different access networks to take part in a tele-meeting or common session whilst all of them simultaneously and automatically consult electronic documents with greatly differing original formats, which are transmitted by means of the Internet.

Another object of the present invention is also to enable different users of work stations that are connected in a local network or firm's network to perform any cooperative work of their choice with other users of work stations that are connected to another local network or firm's network, irrespective of the existence of any obstacle to the transmission of electronic files or data, such as firewalls, proxies etc.

Finally, another object of the present invention is to put into effect a protocol and a system for the automatic and simultaneous distribution of electronic documents of different formats on the Internet, within the framework of applications as varied as presentations to sales teams, the setting-up and conduct of project meetings, distance learning, tele-sales, or inter-firm or intra-firm distribution of information, irrespective of the type of Internet navigator and of the operating system used by each of the user terminals participating in the session.

The protocol of the present invention for the automatic and simultaneous distribution of electronic documents of different formats on the Internet between different users of terminals that are connected by means of different access networks in the course of a common session consisting of common access to a server dedicated to that session is distinguished in that it consists in initializing that session on the initiative of one of the terminal users who is the organizer of that session, the step consisting in initialization comprising at least, following a connection of the terminal of the organizer user to that dedicated server, the drawing-up of a list of the surnames, first names, and electronic addresses of other users who are invited to that session and the selection of the electronic documents to be distributed in the course of that session, in transmitting from the organizer user terminal to the dedicated server the set of electronic documents to be distributed, in their different original formats, accompanied by the list of other invited users and, at the level of the dedicated server, in converting each of the electronic documents to be distributed into a plurality of successive current pages in a unique HTML format and in putting those successive pages on line on the Internet site of that dedicated server, in transmitting, by means of that dedicated server, at least to each of the invited user terminals, a message of invitation to participate in that session, the invitation message comprising at least the address of the site of the dedicated server and the date and the time of the session and, following the connection of at least one of the organizer and/or invited user terminals to that dedicated server during that session, in conditionally authorizing access of each of the user terminals to the plurality of successive current pages on line.

The system of the present invention for the automatic and simultaneous distribution of electronic documents of different formats on the Internet between different users of terminals that are connected by means of different access networks in the course of a common session consisting of common access to a dedicated server is distinguished in that it comprises at least one dedicated server constituting a service platform, that service platform comprising at least a session organizer module which, upon a call on the initiative of one of the terminal users who is the organizer of that session, enables that session to be initialized, this step consisting in initialization comprising at least, following a connection of the terminal of that organizer user to that dedicated server, the drawing-up of a list of the surnames, first names, and electronic addresses of the other users who are invited to that session and the selection of the electronic documents to be distributed in the course of that session, a module for receiving the electronic documents to be distributed and converting them into a plurality of successive current pages in the unique HTML format, a module for putting that plurality of successive current pages in the unique HTML format on line at the level of the site of the dedicated server, a module for transmitting messages of invitation to participate in that session to each of the organizer and invited user terminals, each invitation message comprising at least the address of the site of the dedicated server and the date and the time of the session, and a module for controlling access to the site of the dedicated server by each of the user terminals, that access control module comprising a module for authenticating every organizer user terminal with respect to the service platform and every organizer and invited user terminal with respect to the session organized by the organizer user terminal, respectively.

The protocol and the system of the present invention are applicable to the organization of video sessions or meetings, teleconferences or the like, of forums, and of transactions, by means of the Internet.

### BRIEF DESCRIPTION OF THE SEVERAL VIEWS OF THE DRAWINGS

They will be understood further from a reading of the description and an observation of the following drawings, in which:

FIG. 1 shows, by way of illustration, a flow chart of the basic steps of the implementation of the protocol of the present invention,

FIG. 2A shows, by way of illustration, a variant of the implementation of a step for the transmission of information from a user terminal of an organizer of a session towards a dedicated server, shown in FIG. 1,

FIGS. 2B and 2C show specific forms of messages useful for implementing the protocol of the present invention as shown in FIG. 1,

FIG. 2D shows, purely by way of illustration, an example of the implementation of a method of controlling access to the dedicated server by each invited user terminal, within the framework of the execution of a conditional access to the dedicated server in order to participate in a specific session,

FIG. 3 shows, purely by way of illustration, a method of changing the posting of a current HTML page, which can be implemented by any organizer or invited user terminal in accordance with the method of the present invention,

FIG. 4A shows, by way of illustration, the architecture of a system for the automatic and simultaneous distribution of electronic documents of different formats on the Internet in accordance with the subject of the present invention,

FIG. 4B shows, by way of illustration, an embodiment of the architecture of a dedicated server which is more particularly suitable for the construction of a system according to the subject of the present invention, as shown in FIG. 4A,

FIG. 5 shows by way of illustration, a preferred, non-limiting embodiment a method for the simultaneous posting of an HTML page, from a set of HTML pages on line on a dedicated server, on each of the different user terminals which are organized into a set of users participating in the same session.

### DETAILED DESCRIPTION OF THE INVENTION

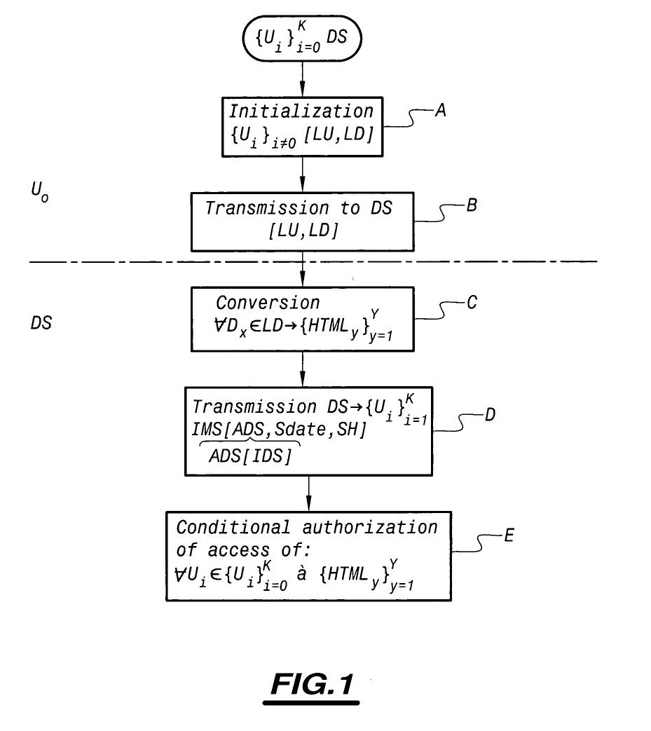

A more detailed description of the protocol according to the present invention for the automatic and simultaneous distribution of electronic documents of different formats on the Internet between different user terminals that are connected by means of different access networks will now be given in relation to FIG. 1 and the following drawings.

In general, a plurality of user terminals designated {Uᵢ}^{K}ᵢ₌₀ is considered, the set of terminals being connected by any means and by different Internet access networks.

It will thus be appreciated that the above-mentioned users are situated at different locations having access to the Internet or to the Intranet by different access networks such as the switched telephone network STN, the high-speed ADSL or “Asymmetric Digital Subscriber Line” network, a LAN local network or firm's network or any Extranet network.

More specifically but in non-limiting manner, the protocol of the present invention is implemented when the above-mentioned set of users {Uᵢ}^{K}ᵢ₌₀ participate in a common session, that session consisting of common access to a dedicated server, indicated DS, which manages the session.

More particularly, it is pointed out that the notion of a session covers any tele-meeting, telephonic conference, video-conference, or the like, in the course of which the above-mentioned set of users are led to consult documents of different formats such as documents in Word®, PowerPoint®, or Excel® formats, documents, images or the like, which are transmitted by means of the Internet.

With regard to the above-mentioned sessions, it is pointed out that classical situations of use relate in particular to cooperative work by people who are working on their firm's network with other people who are located on another firm's network, presentations to sales teams, project meetings, distance learning, tele-sales, or simply the transmission of information within or outside the framework of a firm.

In accordance with the protocol of the present invention, the protocol consists, as shown in FIG. 1, of a step A for the initialization of the session on the initiative of one of the terminal users, that user being designated by definition as the “organizer of the session” and indicated U_{O}.

More specifically, it is pointed out that the initialization step A comprises at least, following a connection of the user terminal of the organizer U_{O} to the dedicated server DS, the drawing-up of a list of surnames, first names, and electronic addresses of the other users who are invited to the session, as well as the selection of the electronic documents to be distributed in the course of the session in question.

In FIG. 1, in step A thereof, the step of drawing up a list of surnames, first names, and electronic addresses of the other invited users consists, for the organizer user, in the definition of the above-mentioned list, which is designated LU, on the basis of the set of users {Uᵢ}_{i≠0}, naturally as well as a list of the electronic documents to be distributed, this list being indicated LD.

More specifically, it is pointed out that the notion of a list is not limiting and that any list may be replaced by a data table, a data structure, or the like.

Step A is then followed by a step B which consists in the transmission, from the user terminal of the organizer U₀ to the dedicated server DS, of the set of electronic documents to be distributed, in their different original formats, accompanied by the list of the other invited users, that is, in short, the lists LU and LD previously defined in step A.

The protocol of the invention is then continued, at the level of the dedicated server DS, and then consists of a step C for converting each of the electronic documents to be distributed into a plurality of successive current pages in a unique HTML format and putting the successive pages on line on the Internet site of the dedicated server DS.

The conversion step is indicated:
∀D_{X} εLD→{HTML_{y}}^{Y}_{y=1}

It will be appreciated from the relationship given above that, for every document D_{X} belonging to the document list LD transmitted, conversion is performed into a set of successive HTML pages, where y indicates an HTML page reference, as will be described further below. The set of HTML pages can then be put on line at the level of the dedicated server DS in conventional manner, but taking account of the reference y attributed to each page, as will be described further below.

Step C is then followed by step D which consists in transmitting a message of invitation to participate in the session by means of the dedicated server DS, at least to each of the invited user terminals.

The message of invitation to participate IMS is indicated:
IMS[ADS,Sdate, SH].

It includes at least the address of the dedicated server, which address is indicated ADS, as well as the date and the time of the session, which are the parameters Sdate and SH.

Naturally, the address ADS of the dedicated server may advantageously be accompanied by a session code in the form of a session identification code linked variable, indicated IDS, the above-mentioned address of the dedicated server, and linked variable then being indicated ADS [IDS].

Naturally, the above-mentioned information is preferably transmitted to each user terminal from the dedicated server DS in secure manner in accordance with conventional security protocols.

The transmission step is indicated
DS→{Uᵢ}^{k}_{i≠1} in step D above.

When the session takes place, that is, on the date and at the time mentioned above, and after attempted connection by each of the user terminals, which are the user terminal of the organizer U_{O} and the terminals of the invited users, the protocol of the invention is then followed by a step E consisting in conditionally authorizing access of each of the user terminals to the plurality of successive current pages on line.

In step E, the conditional access step is indicated
conditional access of
∀Uᵢε{Uᵢ}^{K}ᵢ₌₀ to {HTML_{y}}^{Y}_{y=1}

Naturally, the above-mentioned conditional access is performed on the basis of identifiers of each of the user terminals during the attempted access and naturally of the presentation of the session identification code IDS, as will be described further below.

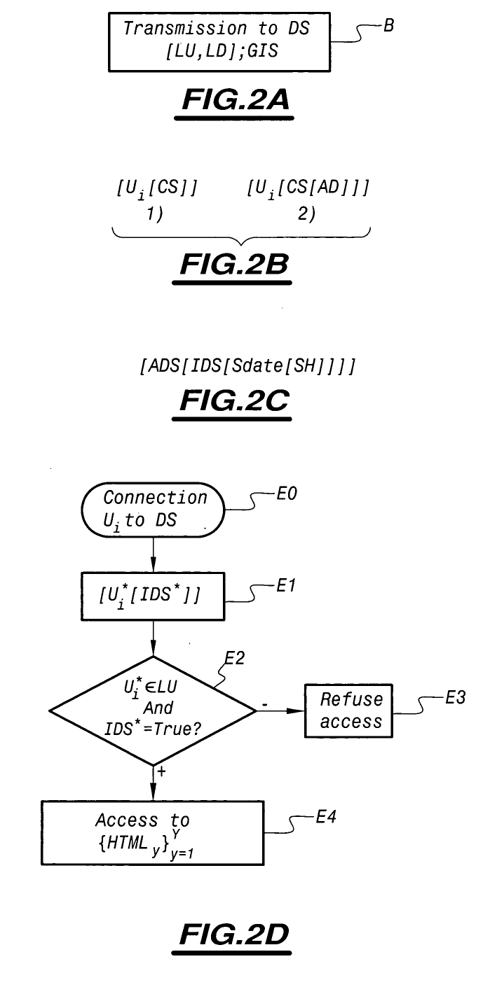

According to a more particular aspect of the implementation of the protocol of the present invention, step B, which consists in initialization, comprises, in addition, the communication to the dedicated server DS of general information relating to the session. This step is shown in FIG. 2A in which the transmission to the dedicated server DS in step B comprises the transmission not only of the list LU of invited users and the list LD of documents selected, but also of general information, indicated GIS, relating to the above-mentioned session.

By way of non-limiting example, it is pointed out that the general information may comprise, for example, the subject of the session, the expected duration of the session, a list of names of people taking action in the session, and a list of subjects of their action.

Moreover, and according to a particularly distinguishing aspect of the protocol of the present invention, the initialization step further comprises the attribution by the organizer user U_{O}, of specific rights of action to each of terminals of the invited users {Uᵢ}_{i≠0}.

The specific rights of action comprise at least the right of consultation only, indicated CS, of each successive page HTML_{y}, or the right of consultation and addition of electronic documents that are distributed in the course of the session.

For this purpose, as shown by way of non-limiting example in FIG. 2B, there may be added to each element of the list LU, that is, to each user identifier Uᵢ, a linked variable CS corresponding to a code of a consultation-only right, as shown in point 1) of FIG. 2B or, where appropriate, another linked variable as shown in point 2) of FIG. 2B, this other linked variable, defined [CS[AD]], corresponding to the definition of the right of consultation CS and of addition AD of electronic documents that are distributed in the course of the session.

The coding of the specific rights of action in accordance with the consultation-only right or the consultation and addition right, as shown in FIG. 2B, is given by way of example, any other form of coding being possible.

A more detailed description of the step consisting in authorizing access the dedicated server DS by each of the invited user terminals will now be described with reference to FIGS. 2C and 2D.

FIG. 2C shows, by way of non-limiting example, a particular form of the transmission message IMS sent by the dedicated server DS to each of the user terminals in step D.

This message includes, amongst other things, the session identification code IDS which can be extracted at the level of each user terminal Uᵢ.

Step E may then, by way of non-limiting example, be implemented more specifically, as shown in FIG. 2D.

At the time of participation in the session in question, of code IDS, that is, upon the connection of the user terminal Uᵢ to the server DS, in step E₀, the identification parameters of the user Uᵢ and the identification parameters of the session IDS are also transmitted; the values transmitted are indicated U*ᵢ and IDS*, respectively, and are detected, in step E₁ at the level of the dedicated server DS.

A conditional step of authentication of the terminal of the invited user Uᵢ in question is then performed in step E₂, this authentication step being performed with respect to the dedicated server.

By way of non-limiting example, the above-mentioned authentication may comprise checking that the identification parameters U*ᵢ transmitted belong to the list LU received by the dedicated server DS upon initialization and then checking the correct value of the session identification code IDS by comparison of the identification code value IDS* transmitted in step E₁ with the original session identification code IDS stored at the level of the dedicated server DS.

Upon a negative response to the authentication test E₂, a step E₃ for refusing access to the user terminal Uᵢ is invoked. Upon a positive response to the authentication test E₂, on the other hand, step E₄ of access to the set of pages {HTML_{y}}^{Y}_{y=1} is then invoked for the user terminal Uᵢ, within the framework of the session in question.

Naturally, the steps of checking the user and session identification codes may be performed by the most appropriate methods, these methods corresponding to conventional operations which may involve enciphering/deciphering operations or signature checking operations, for example.

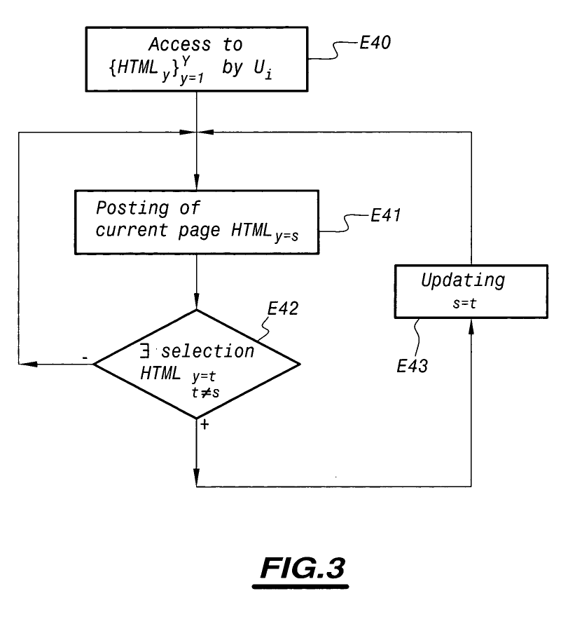

Finally, a more detailed description of the method for the automatic and simultaneous display of the same current HTML page by the set of invited users and/or the organizer user will now be given with reference to FIG. 3.

FIG. 3 shows by way of non-limiting example a detail of the method of access to the set of HTML pages defined in step E₄ of FIG. 2D.

The general method shown in FIG. 3 is implemented for at least one of the invited user terminals and, naturally, for the organizer user terminal, in order to ensure access to the plurality of successive current pages on line, in accordance with a synchronized access, for which access has been accepted, and automatically and simultaneously displays the same HTML page of the plurality of successive current pages in the unique HTML format on line.

The same applies to the organizer user terminal.

According to a distinguishing aspect of the protocol of the present invention, the automatic and simultaneous display of the same HTML page of the plurality of current pages {HTML_{y}}^{Y}_{y=1} in the unique HTML format on line is controlled on the initiative of each of the organizer and/or invited user terminals. Each participant in the session is thus enabled to control and/or to change the current HTML page posted on each user terminal participating in the session.

Thus, with reference to FIG. 3, it is indicated that the method of posting and of automatic and simultaneous display is described for any user terminal of any index i of the set of invited users or the organizer user.

When access to the above-mentioned set of HTML pages has been performed following the authorized conditional access, in step E₄₀, according to the consultation rights attributed to the user Uᵢ in question, for consultation only or consultation and addition of electronic documents distributed in the course of the session, the posting of a welcome page, for example, for the session is considered, by way of non-limiting example, upon access by the first user terminal, that is, any one of the invited or organizer user terminals; by way of non-limiting example, the welcome page enables general information, transmitted as described in the foregoing description, to be posted.

When, on the other hand, the session has already started and access by the user terminal Uᵢ is subsequent to the start of the session by the organizer user, the HTML page posted is the current HTML page.

In all cases, this posting operation is represented in step E₄₁ of FIG. 3. The page posted is either the welcome page or a current page already introduced by the organizer user or, where applicable, one of the invited users.

In the course of the session, each invited and/or organizer user and, in particular, the terminal of the organizer, checks that the posting of the current HTML page conforms to the posted HTML page selected either by the organizer user U₀ or by one of the invited users Uᵢ, each of these users being able, upon request, to address to the dedicated server DS the posting of a specific HTML page.

Interrogation to discriminate such a selection by each of the user terminals Uᵢ is then advantageously executed by means of a periodic interrogation of the dedicated server DS by each of the organizer and/or invited user terminals.

A test for the existence of a different selection for the posting of specific HTML pages is performed in step E₄₂, this test is indicated:
∃ selection HTML_{y=t}
   t≠s

Upon a negative response to the above-mentioned selection test E₄₂, the posting of the current HTML page HTML_{y=S} is maintained.

Upon a positive response to the selection test E₄₂, on the other hand, an updating of the posting of the HTML page at the level of the user terminal Uᵢ is performed in step E₄₃. The above-mentioned updating is performed by a transaction between the invited or organizer user terminal Uᵢ in question with the dedicated server DS, as will be described further below.

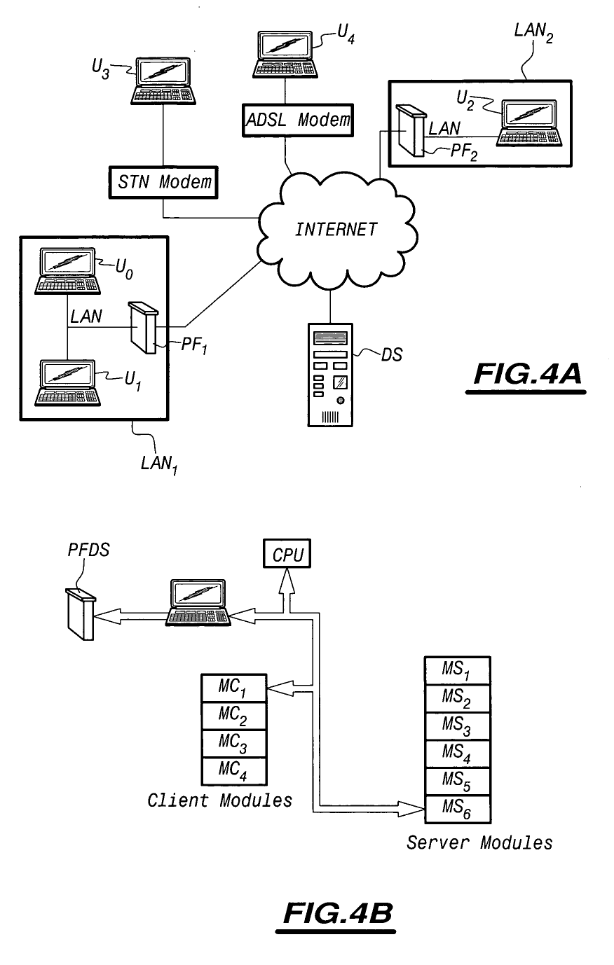

A more detailed description of a system according to the present invention for the automatic and simultaneous distribution of electronic documents of different formats on the Internet between different users of terminals that are connected by means of different access networks will now be given in relation to FIGS. 4A and 4B.

FIG. 4A shows the architecture of a distribution system according to the present invention.

As shown in the above-mentioned drawing, the set of users participating in a session comprises an organizer user U_{O} and four invited users whose terminals are indicated U₁ to U₄.

The set of users is connected on the network to the Internet by means of Internet access providers, not shown in the drawings.

By way of non-limiting example, the organizer user U_{O} and the invited user U₁ are situated in the same firm and are connected in a local network LAN₁ with a firewall PF₁ protecting the firm's network from the Internet.

Similarly, the invited user U₂ is connected to the Internet by means of a firewall PF₂ and a local network LAN₂.

Finally, the invited users U₃ and U₄ are connected directly to the Internet via their access providers, not shown, but with the use, by way of non-limiting example, of an STN modem and a high-speed ADSL modem, respectively, for example.

The firewalls are considered to have standard HTTP open ports which corresponds to the most general case for all firewalls.

As far as the dedicated server DS is concerned, it is pointed out that it in fact constitutes a service platform which enables the set of transactions to be executed between each organizer and/or invited terminal user on the basis of client/server type transactions.

As shown in FIG. 4B, the dedicated server DS is constituted by a computer which is connected to the Internet network by a specific firewall indicated PFDS, the computer and its central processing unit CPU having specific software modules which are categorized as client modules, indicated MC₁ to MC₄ and server modules indicated MS₁ to MS₆.

In conventional manner, each client or server software module can be stored in the most suitable manner either in a read-only memory, which is reprogrammable if necessary, or on a disc for saving and reloading into the working memory according to need, in dependence on successive accesses to the service platform thus constituted.

In general, it is pointed out that the client software modules are software modules which, following access of any user Uᵢ, that is the organizer user U_{O} or an invited user, are executed on the initiative of those users, the set of client software modules, however, being installed at the level of the service platform and of the dedicated server DS.

By way of non-limiting example, the client software modules have the following functions:
MC₁: document presentation module;
MC₂: document transfer module;
MC₃: HTML page synchronization module;
MC₄: meeting management module.

With regard to the server software modules, which are installed at the level of the service platform, they are executed on the initiative of the dedicated server DS or, where appropriate, in response to any request emanating from one of the organizer and/or invited users.

By way of non-limiting example, it is pointed out that the server software modules comprise the following functions:
MS₁: module for managing rights of access to meetings;
MS₂: HTML page synchronization module;
MS₃: module for receiving documents in different formats;
MS₄: module for converting documents to HTML format;
MS₅: module for managing invited users and sessions;
MS₆: module for access to HTML pages and documents filed.

The various functions of the client and server software modules will now be given below:

Client Modules

MC₁: Document Presentation Module:

The above-mentioned module enables any organizer user U_{O} to select the documents which he wishes to distribute in the course of the session, these documents being selected and stored in their original format with a view to their transmission to the dedicated server DS.

MC₂: Document Transfer Module:

The document transfer module prepares and transfers the selected documents in their original format to the dedicated server Ds from the organizer user terminal U_{O}. Finally, after a meeting has been announced, the document transfer module MC₂ enables the organizer user and those invited users who have been attributed consultation and addition rights as described above with reference to FIG. 2B, to transfer electronic documents to be distributed, either before or during the session or meeting.

MC₃: HTML Page Synchronization Module:

This module synchronizes the HTML pages as described with reference to FIG. 3. In particular, it performs the selection test step E₄₂ at the level of each invited and/or organizer user terminal; this selection step is described further below. In particular, the above-mentioned client software module also controls step E₄₃ for the updating of the HTML page to be posted at the level of the user terminal in question.

MC₄: Meeting Management Module:

This module is a meeting management module. In particular, it not only enables the lists LU of invited users and the lists LD of documents as drawn up in step A to be defined but also enables the composition of the general information GIS relating to the session to be ensured and, finally, permits any administrative operation for the organization of the meetings or sessions by the organizer user.

Server Modules

MS₁: Module for Managing Rights of Access to Meetings:

The above-mentioned module can discriminate the specific rights of intervention granted to each invited user, that is the right of consultation only or the right of consultation and addition of documents, on the basis of the information transmitted in step B of FIG. 1 and of FIG. 2B.

The above-mentioned module enables the fields of the variables relating to the above-mentioned encoded rights to be read, whether they are encoded in list form or in other form.

MS₂: HTML Page Synchronization Module

Following the connection of one or a plurality of organizer and/or invited users, the above-mentioned module has the function of automatically synchronizing all of the navigators with which the user terminals that are connected and participating in the session are equipped. The above-mentioned module automatically ensures, in particular, any change of HTML page to be posted following the request of a user participating in the meeting, as described above in the description with reference to FIG. 3. A more detailed description of the method of operation for ensuring the change of posting of the current HTML page, at the level of the dedicated server DS, by means of the above-mentioned module MS₂ will be given below.

MS₃: Module for Receiving Documents in Different Formats:

The document-receiving module is a module that is normally available commercially. After the transmission of electronic files to be distributed, it ensures the storage and protection of the files in a temporary data base, nevertheless permitting archiving of the above-mentioned documents. The method of operation of such a receiving module will not be described in detail.

MS₄: Module for Converting Documents to HTML Format:

This server software module is a module that is normally available commercially and may consist, for example, of a “Purepage” module marketed by the company Inzone Software (NZ). This type of software enables more than 200 file formats and, in particular standard Microsoft® files, image files, Lotus® files, etc. to be converted into HTML pages. Once the set of files has been converted, the HTML pages and the set of pages {HTML_{y}}^{Y}_{y=1} is automatically put on line on the site of the dedicated server DS.

MS₅: Module for Managing the Invited Users and Sessions:

The above-mentioned module ensures the management of the list of users invited to the meetings or sessions. By way of non-limiting example, it is pointed out that the above-mentioned server module ensures discrimination between the organizer user and invited users in order subsequently to permit suitable access control according to the authorization of the latter.

MS₆: Module for Access to HTML Pages and Documents Filed:

This module ensures access to the set of HTML pages and to the documents filed. In a non-limiting embodiment, the above-mentioned module enables a reference y comprising a serial number to be attributed to each page HTML_{y} belonging to the set of pages to be transmitted. According to an advantageous characteristic of the method and of the system of the invention, it is pointed out that each serial number corresponds unambiguously to the address of the corresponding page HTML_{y} on the site of the dedicated server DS.

The system of the present invention as shown in FIGS. 4A and 4B is therefore used as follows:

First of all the organizer user U_{O} initializes the meeting or session in accordance with the steps described above in FIGS. 1 et seq. of the description. In particular:
he connects himself to the dedicated server DS by means of a simple conventional navigator with the use of the HTTP protocol;
he then enters general information GIS relating to the meeting, purpose of the meeting, timetable, etc., as described above;
he enters the surnames, first names, and electronic addresses of the invited users participating in the session and indicates the consultation rights attributed to them within the framework of the above-mentioned session; this operation corresponds to the drawing-up of the above-mentioned lists LU and LD.

Each of the invited users Uᵢ is then automatically invited to the meeting by the transmission of an invitation message by e-mail, for example.

When the documents to be distributed and the list of invited users has been transmitted to the dedicated server DS, the above-mentioned operations being executed on the dedicated server DS or on the service platform when the dedicated server DS and the service platform are separate, the documents transmitted for distribution are converted and then put on line.

Subsequently, on the date and at the time of the opening of the session, the participants, including the organizer user, then connect themselves to the dedicated server DS and authenticate themselves. The authentication procedure for each user, that is, the organizer user and the invited users, may be similar.

By way of non-limiting example, on the date and at the time of the session, the dedicated server DS may prepare a suggested welcome page for posting to any subsequent user.

All of the users participating in the meeting can then automatically and simultaneously display the same current HTML page, that is, firstly the welcome page and then, subsequently, on the initiative in the first place of the organizer user, for example, the sequence of successive current HTML pages, which sequence is modified, if necessary, by the intervention of an invited user.

Thus, in dependence on the rights given by the organizer user U_{O} to the invited users {Uᵢ}^{K}ᵢ₌₁, the invited users can also control the meeting or the session and, in particular, can modify the selection of the current HTML page that is posted on the Internet navigator of the set of users taking place in the meeting or session.

Naturally, at any moment in the course of the session, a new invited user may be welcomed to the circle of participants and each participant, according to the rights attributed by the organizer ab initio, can file new documents for distribution within the framework of the same session.

In a variant, each participant can, if required, enter or leave the synchronized mode in order, if necessary, to be able to consult HTML pages of the set of HTML pages submitted for distribution, the consultation this time taking place freely. In such a situation, the activity of the organizer and/or invited user who has left the synchronized consultation mode is, within the framework of the session, simply put to sleep and a limited time may, for example, be granted to him for free consultation of these documents. In any case, the ability of one or other of the users to change to free consultation mode can be controlled in the following manner:
automatic attribution of the change to free mode for the organizer user U_{O};
attribution of consultation mode in free mode on the initiative of the organizer user for each of the invited users; for this purpose, the coding of the rights as shown in FIG. 2B may be completed by a third linked variable not shown in portion 2) of FIG. 2B, this third linked variable corresponding to the coding of the ability to change to consultation in free mode.

With regard to the implementation of the system of the invention, it is pointed out that the equipment necessary for implementing the system at the level of each organizer and/or invited user consists simply of a computer, that is, a work station or terminal equipped with Web navigator software without the addition of “plug in” computer programs. The above-mentioned work station is then simply connected to a firm's Intranet network or directly to the Internet network, as shown in FIG. 4A.

The system of the present invention requires no downloading or installation of further software. Finally, all of the client software modules as described in FIG. 4B are preferably installed at the level of the service platform, for example or, if necessary, of the dedicated server DS and each can be executed at the level of each invited user terminal.

Whereas all operating systems and types of connection to the network can be used for implementing the system of the invention, the service as a whole operates at low transmission rates and, naturally, is accessible at all points of the Internet network.

Finally, the documents that are presented for distribution, and are converted into HTML pages, are put on line on the dedicated server DS which is installed in the network at any location, thus avoiding intrusions at the work station of the organizer user U_{O} whereas, on the other hand, any invited user can file new documents in the course of the meeting, provided that the corresponding consultation rights have been attributed to him.

It will thus be appreciated that the system and the method of the present invention can also ensure the execution of multiple transactions between the various organizer and/or invited user terminals, the dedicated server DS being able to have conferred on it, in particular, the authority of a trusted third party which is enabled to receive the filing of electronic files to be distributed, which also ensures the implementation of electronic transactions between parties having conflicting interests to defend, although, naturally, these parties are participating in the same session or meeting.

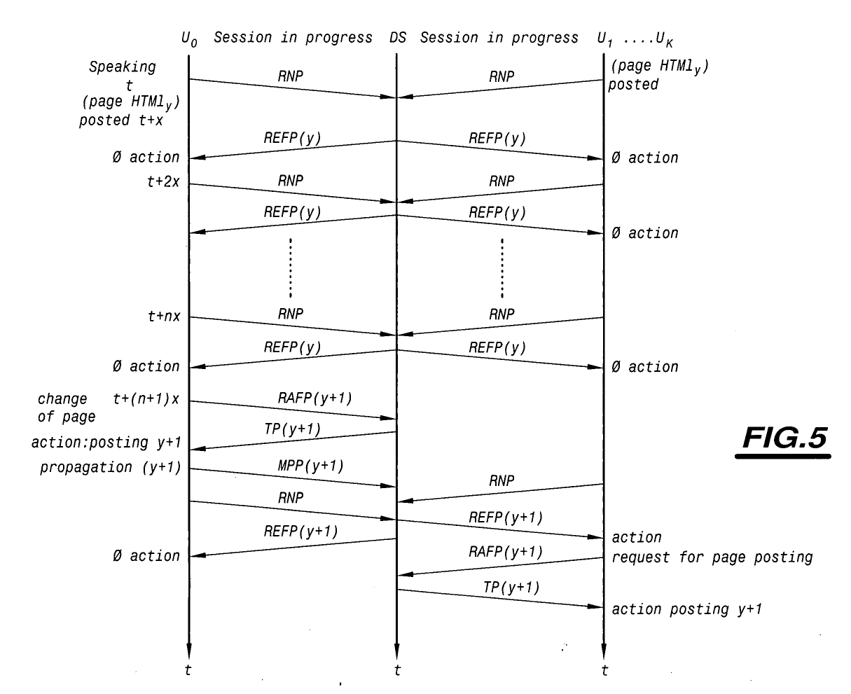

A more detailed description of a method for the simultaneous posting of a current HTML page from a set of HTML pages on line on a dedicated server, on each of the terminals of various users organized in a set of users participating in the same session, will now be given with reference to FIG. 5.

The above-mentioned method can be implemented so as to execute the simultaneous and synchronized posting of the set of above-mentioned pages on all of the organizer and/or invited user terminals in step E₄ of FIG. 2D.

Within the framework of FIG. 5, the situation between an organizer user U_{O} and another, invited user U₁ to U_{K}, is considered by way of non-limiting example.

In particular, the organizer user, for example, is considered to be speaking, within the framework of the session or of the meeting, and the HTML page that is posted, the current HTML page, is considered to be the page carrying the reference y and a predetermined serial number; this page may correspond either to the welcome page, or to any page previously selected by the organizer user U_{O} or, where appropriate, any other invited user.

It is indicated in FIG. 5 that, between the moment t+x of representation of the actions for the organizer user U_{O} and the invited users U₁ to U_{K} and the moment t+nx, where x represents a predetermined time value and n any indefinite number, no action is undertaken by the organizer user U_{O} or by the invited user U₁ to U_{K}. In these conditions, each organizer and/or invited user terminal transmits so-called periodic scanning messages RNP comprising a request to check the continued posting of the current HTML page of reference y on each of the terminals participating in the session, that is, for all of the users U_{O} to U_{K}. Each scanning message RNP transmitted from each user terminal to the dedicated server DS is followed by a routine response from the dedicated server DS to each of the user terminals by means of a response message of continued posting of a predetermined HTML page.

As a result, between the moments t+x and t+nx and in the absence of any change or request for a change of page posting, the response message of continued posting of an HTML page, which message is marked REFP_{(y)}, transmits to each of the terminals the reference y enabling the posting of the current HTML page with the same index y to be maintained on each of the user terminals.

Each of the user terminals then executes the procedure shown in FIG. 3 and, in particular, the test for the existence of a selection or a change in posting selection E₄₂. The continued posting of the HTML page of reference y is marked Ø action.

When, on the other hand, a user terminal wishes to change the HTML page posting, the method of the invention shown in FIG. 5 consists, for each requesting user terminal, that is, by way of example, in FIG. 5, for the organizer user terminal U_{O}, at the moment t+(n+1)x, in transmitting, on the initiative of that requesting user terminal, to the dedicated server DS, a request for the posting of a current HTML page different from the preceding one by means of a posting request designated RAFP carrying, for example, the reference y+1 in order to obtain the next page, and then in transmitting from the dedicated server DS to the requesting user terminal, that is the organizer terminal U_{O}, the page HTML_{(y+1)}, by a page transmission message marked TP_{(y+1)}.

At the level of the requesting user terminal, that is the organizer terminal U_{O}, the action then consists in posting the HTML page, the reference of which is y+1 and which has just been received.

The above-mentioned posting operation is then followed by an operation which consists in transmitting from the requesting user terminal, that is the organizer terminal U_{O}, to the dedicated server DS, a propagation message for the simultaneous posting of the current HTML page of reference y+1 with respect to the other user terminals participating in the session. The posting propagation message is marked MPP_{(y+1)}. In particular, it will be appreciated that the propagation message for the simultaneous posting of the current HTML page of reference y+1 also constitutes an acknowledgement of receipt by the organizer terminal U_{O} of the above-mentioned HTML page transmitted by the message TP_{(y+1)}.

The simultaneous posting process is then repeated by means of the other, non-requesting user terminals, that is the user terminals other than the user terminal U_{O}, that is the invited user terminals U₁ to U_{K}.

Naturally, this procedure is performed by means of periodic scanning messages which are transmitted by each of the above-mentioned terminals, that is, not only by the invited terminals U₁ to U_{K}, which are terminals not requesting a change of posting, but also by the terminal requesting posting, that is the organizer user terminal U_{O}.

Naturally, the response message REFP also includes the reference to the HTML age to be posted, that is the reference y+1 confirmed by the previous propagation message MPP_{(Y+1)}.

When the response message REFP for continued posting of an HTML page includes a reference of an HTML page to be posted which is identical to the reference of the current HTML page posted on the terminal receiving the message, which is the case for the requesting user terminal, that is the organizer user terminal U_{O}, the receipt of the continued posting message REFP_{(y+1)} by the latter terminal is not followed by any action since, naturally, the HTML page of reference y+1 is already posted. The posting of the current HTML page is thus maintained.

When, on the other hand, the response message of the continued posting of an HTML page includes a reference of a HTML page to be posted which is different from the reference of the current HTML page, which is the case for the non-requesting user terminals, that is the user terminals U₁ to U_{K}, immediately after the moment t+(n+2)x in FIG. 5, each of the non-requesting, invited user terminals, that is the user terminals U₁ to U_{K}, then transmits to the dedicated server DS an HTML page posting request message for the reference y+1 as shown in FIG. 5. The above-mentioned dedicated server transmits, in response to each of the non-requesting, invited user terminals U₁ to U_{K}, an HTML page message TP_{(y+1)}. The action undertaken at the level of each of the non-requesting, invited user terminals U₁ to U_{K} then consists in the posting of the HTML page of reference y+1 received.

With regard to the method of operation for the above-mentioned synchronization of the posting of the HTML pages, it is pointed out that the notion of synchronization corresponds to that of a factual synchronization and not to a temporal synchronization of the actual posting of each current HTML page on the set of user terminals, by reason of the asynchronous nature of the transmissions between each of the user terminals and the dedicated server DS.

In particular, it will be appreciated that each HTML page of the set of HTML pages on line is attributed a reference number, that is the reference y or y+1 in FIG. 5, which includes a unique serial number corresponding unambiguously to the address of the HTML page on the site of the dedicated server, as mentioned above in the description.

This method of operation enables access by each of the organizer or invited user terminals to be controlled in dependence on the rights of consultation only and of consultation and addition of the electronic documents distributed by one of the user terminals. In particular, each HTML page resulting from addition of additional electronic documents, either prior to the opening of the session or meeting or during the session or meeting is allocated a reference comprising a serial number.

This method of operation thus ensures synchronous and automatic consultation of the HTML pages posted for the set of users participating in the session in question.

In practice, it is pointed out that, for each user terminal, the periodic scanning messages RNP may be emitted by each of the terminals participating in the session within a range of periods of between 3 seconds and 2 minutes.

Naturally, at the level of each user terminal, the detection of the change of page to be posted may be performed, as shown in FIGS. 3 and 5, by virtue of the transactions between the user terminal and the dedicated server DS in order to perform the transactions that are necessary for the change in page posting.

1. A protocol for the automatic and simultaneous distribution of electronic documents of different formats on the Internet between different users of terminals that are connected by means of different access networks in the course of a common session consisting of common access to a server dedicated to the said session, wherein the protocol consists in:
a) initializing the said session on the initiative of one of the terminal users who is the organizer of the said session, the step consisting in initialization comprising at least, following a connection of the terminal of the said organizer user to the said dedicated server, the drawing-up of a list of surnames, first names, and electronic addresses of other users who are invited to the said session and the selection of the electronic documents to be distributed in the course of the said session,
b) transmitting, from the said organizer user terminal, to the said dedicated server, the set of electronic documents to be distributed in their different original formats, accompanied by the list of the other invited users and, at the level of the said dedicated server,
c) converting each of the electronic documents to be distributed into a plurality of successive current pages in a unique HTML format and putting the said successive pages on line on the Internet site of the said dedicated server,
d) transmitting, by means of the said dedicated server, at least to each of the said invited user terminals, a message of invitation to participate in the said session, the said invitation message comprising at least the address of the site of the said dedicated server and the date and the time of the said session and, following the connection of at least one of the said organizer and/or invited user terminals to the said dedicated server during the said session,
e) conditionally authorizing access of each of the said user terminals to the plurality of successive current pages on line.

2. A protocol according to claim 1, wherein the said step consisting in initialization further comprises the communication to the said dedicated server of general information concerning the session.

3. A protocol according to claim 1, wherein the said step consisting in initialization further comprises the attribution by the organizer user of specific rights of action to each of the said invited user terminals, the said specific rights of action comprising at least the right of consultation only or the right of consultation and addition of electronic documents distributed in the course of the said session.

4. A protocol according to claim 1, wherein the step consisting in authorizing access to the said at least one of the invited user terminals comprises a conditional step of authentication of the said at least one of the invited user terminals with respect to the said dedicated server.

5. A protocol according to claim 1, wherein access of the said invited user terminals to the plurality of successive current pages on line is synchronized access, each authorized invited user whose access has been accepted automatically and simultaneously displaying the same HTML page of the said plurality of successive current pages in the unique HTML format on line.

6. A protocol according to claim 5, wherein the said automatic and simultaneous display of the same HTML page of the said plurality of successive current pages in the unique HTML format on line is controlled on the initiative of each of the organizer and/or invited user terminals, each participant in the said session being enabled to control and/or change the HTML page posted on each user terminal participating in the said session.

7. A protocol according to claim 1, wherein the access of each of the organizer and invited user terminals to the said dedicated server is executed by each of the said terminals by means of a periodic interrogation of the said dedicated server.

8. A system for the automatic and simultaneous distribution of electronic documents of different formats on the Internet between different users of terminals that are connected by means of different access networks in the course of a common session consisting of common access to a dedicated server, wherein it comprises at least one dedicated server constituting a service platform, the said service platform comprising at least:
a session organizer module which, upon a call on the initiative of one of the terminal users which is the organizer of the said session, enables the said session to be initialized, the step consisting in initialization comprising at least, following a connection of the terminal of the said organizer user to the said dedicated server, the drawing-up of a list of the surnames, first names, and electronic addresses of the other users who are invited to the said session and the selection of the electronic documents to be distributed in the course of the said session,
a module for receiving the said electronic documents to be distributed and converting them into a plurality of successive current pages in the unique HTML format,
a module for putting the said plurality of successive current pages in the unique HTML format on line at the level of the site of the said dedicated server,
a module for transmitting messages of invitation to participate in the said session to each of the said organizer and invited user terminals, each invitation message comprising at least the address of the site of the said dedicated server and the date and the time of the said session, and
a module for controlling access to the site of the said dedicated server by each of the user terminals, the said access control module comprising a module for authenticating every organizer user terminal with respect to the service platform and every organizer and invited user terminal with respect to the said session organized by the said organizer user terminal, respectively.

9. A system according to claim 8, wherein each message of invitation to participate in the said session to each of the said organizer and invited user terminals comprises, in addition to the address of the site of the said dedicated server, a password dedicated to the said session and to each of the organizer and invited user terminals.

10. A method for the simultaneous posting of a current HTML page from a set of HTML pages on line on a dedicated server on each of the terminals of different users that are organized into a set of users participating in the same session, wherein the method consists in:
transmitting, on the initiative of one of the user terminals, that is the requesting user terminal, to the said dedicated server, a request for the posting of the said current HTML page,
transmitting the said current HTML page from the said dedicated server to the said requesting user terminal,
posting the said current HTML page at the level of the said requesting user terminal,
transmitting from the said requesting user terminal to the said dedicated server, a message for the simultaneous propagation of the posting of the said current HTML page with respect to the other user terminals participating in the said session,
transmitting, from each of the said terminals participating in the said session to the said dedicated server a periodic scanning message comprising a request for confirmation of continued posting of the said current HTML page on each of the said terminals participating in the said session,
transmitting, from the said dedicated server to each of the terminals of the said users participating in the said session a response message for the continued posting of the said page of an HTML page, this response message of continued posting comprising a reference of the HTML page to be posted, which is identical to or different from the reference of the said current HTML page and, upon receipt of a response message of continued posting comprising a reference of the HTML page to be posted which is identical to or different from the reference of the said current HTML page,
maintaining the posting of the said current HTML page on each of the user terminals participating in the said session and, on receipt of a response message for continued posting comprising a reference of the HTML page to be posted different from the reference of the said current HTML page and relating to another HTML page,
transmitting from each of the user terminals participating in the session to the said dedicated server, a message requesting access to the said other HTML page, and
transmitting from the said dedicated server to each of the said user terminals participating in the session, the said other HTML page,
posting, on each of the user terminals, the said other HTML page, which is subsequently taken as the current HTML page.

11. A method according to claim 10, wherein, a reference number comprising a unique serial number is attributed to each HTML page of the said set of HTML pages on line, the reference number corresponding unambiguously to the address of the said HTML page on the site of the said dedicated server, enabling access by each of the said user terminals to be controlled according to rights of consultation only and of consultation and addition of electronic documents distributed by one of the user terminals, a reference comprising a successive serial number being allocated to each HTML page resulting from the addition of additional electronic documents.

12. A method according to claim 10, wherein the said periodic scanning messages are emitted by each user terminal participating in the said session within a range of periods of between 3 seconds and 2 minutes.

13. A method according to claim 11, wherein the said periodic scanning messages are emitted by each user terminal participating in the said session within a range of periods of between 3 seconds and 2 minutes.
